(19) United States
(12) Patent Application Publication
(10) Pub. No.: US 2026/0167206 A1
(43) Pub. Date: Jun. 18, 2026

(54) VOICE ACTIVATED ADVANCED DRIVER ASSISTANCE SYSTEM FOR VEHICLE

(71) Applicant: GM Global Technology Operations LLC, Detroit, MI (US)

(72) Inventors: Andrew Wassef, Novi, MI (US); Kevin A. O'Dea, Ann Arbor, MI (US); Namal P. Kumara, Ypsilanti, MI (US); Paul A. Adam, Milford, MI (US)

(73) Assignee: GM Global Technology Operations LLC, Detroit, MI (US)

(21) Appl. No.: 18/979,262

(22) Filed: Dec. 12, 2024

(51) Int. Cl. B60W 50/00; B60W 40/08; B60W 50/14; G10L 15/22

(52) U.S. Cl. CPC B60W 50/0098; B60W 40/08; B60W 50/14; G10L 15/22; B60W 2040/089; B60W 2520/10; B60W 2540/21; B60W 2540/215; B60W 2540/225; G10L 2015/223; G10L 2015/225

(57) ABSTRACT

A computer-implemented method when executed by data processing hardware causes the data processing hardware to perform operations. The operations include receiving, at a virtual control module, a voice command and processing, via a voice assistant architecture of the virtual control module, the voice command. The operations also include confirming, via the voice assistant architecture, the voice command and executing, via an advanced driver assistance system (ADAS) of a vehicle, one or more ADAS operations in response to the confirmed voice command.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a voice activated advanced driver assistance system for a vehicle.

Vehicles are often equipped with driver assistance systems, such as cruise control and lane assist. The assistance systems can be activated by a driver through menu options on a user interface and/or through buttons on a steering wheel. Settings are often configured within various layers of menu selections, which may be accessed using one or both of the user interface and buttons on the steering wheel. While vehicles are often configured to make the settings accessible, the user may need to stop or pull over the vehicle to make appropriate adjustments to the settings. In other instances, the user may need to cycle through various settings before arriving at a selection. Thus, there is a need for an improved method and system for manipulating driver assistance systems of a vehicle.

### SUMMARY

In some aspects, a computer-implemented method when executed by data processing hardware causes the data processing hardware to perform operations. The operations include receiving, at a virtual control module, a voice command and processing, via a voice assistant architecture of the virtual control module, the voice command. The operations also include confirming, via the voice assistant architecture, the voice command and executing, via an advanced driver assistance system (ADAS) of a vehicle, one or more ADAS operations in response to the confirmed voice command.

In some examples, confirming the voice command may include projecting, via a speaker system of the vehicle, the voice command. Optionally, confirming the voice command may include receiving, from a driver monitoring system, a confirmation command in response to the projected voice command. In some instances, the voice assistant architecture may be configured with operation modes. The operation modes may include at least one of a wait mode, a process mode, a confirmation mode, and an execution mode. The operations may also include reverting to the wait mode of the voice assistant architecture in response to the executed ADAS operation. In some configurations, executing the one or more ADAS operations may include executing at least one of a brake command, a steering command, and a torque command. Optionally, the one or more ADAS operations may include one or more of speed control, lane assist, path follow, lane change, braking assist, and adaptive cruise control. In some instances, confirming the voice command may include receiving gaze data, at the virtual control module, from a driver monitoring system of the vehicle. In other examples, executing the one or more ADAS operations may include determining at least one of a vehicle position and a speed profile of the vehicle.

In other aspects, a voice activated system for a vehicle includes data processing hardware and memory hardware in communication with the data processing hardware. The memory hardware stores instructions that when executed on the data processing hardware cause the data processing hardware to perform operations. The operations include receiving, at a virtual control module, a voice command and processing, via a voice assistant architecture of the virtual control module, the voice command. The operations also include confirming, via a speaker system of a vehicle, the voice command and executing, via an advanced driver assistance system (ADAS), one or more ADAS operations in response to the confirmed voice command.

In some examples, confirming the voice command may include projecting, via a speaker system of the vehicle, the voice command. Optionally, confirming the voice command may include receiving, from a driver monitoring system, a confirmation command in response to the projected voice command. The voice assistant architecture may be configured with operation modes, and the operation modes may include at least one of a wait mode, a process mode, a confirmation mode, and an execution mode. The operations may also include reverting to the wait mode of the voice assistant architecture in response to the executed ADAS operation. In some instances, executing the one or more ADAS operations may include executing at least one of a brake command, a steering command, and a torque command. The one or more ADAS operations may include one or more of speed control, lane assist, path follow, lane change, braking assist, and adaptive cruise control. In some examples, confirming the voice command may include receiving gaze data, at the virtual control module, from a driver monitoring system of the vehicle. Optionally, executing the one or more ADAS operations may include determining at least one of a vehicle position and a speed profile of the vehicle.

In further aspects, a voice activated system for a vehicle includes data processing hardware and memory hardware in communication with the data processing hardware. The memory hardware stores instructions that when executed on the data processing hardware cause the data processing hardware to perform operations. The operations include receiving, at a virtual control module, a voice command, processing, via a voice assistant architecture of the virtual control module, the voice command, and confirming, via a speaker system of the vehicle, the voice command. The operations also include receiving, from a driver monitoring system, a confirmation command in response to the projected voice command, executing, via an advanced driver assistance system (ADAS), one or more ADAS operations in response to the confirmed voice command, and reverting to a wait mode of the voice assistant architecture in response to the executed ADAS operation.

In some examples, the voice assistant architecture may be configured with operation modes, and the operation modes may include at least one of a wait mode, a process mode, a confirmation mode, and an execution mode.

### BRIEF DESCRIPTION OF THE DRAWINGS

The drawings described herein are for illustrative purposes only of selected configurations and are not intended to limit the scope of the present disclosure.

FIG. 1 is a schematic diagram of a voice activated system for a vehicle according to the present disclosure;

FIG. 2 is a block diagram of a voice activated system according to the present disclosure;

FIG. 3 is another block diagram of the voice activated system of FIG. 2;

FIG. 4 is a schematic diagram of vehicles on a roadway, one of the vehicles equipped with a voice activated system and an advanced driver assistance system according to the present disclosure;

FIG. 5 an exemplary flow diagram of a voice activated system according to the present disclosure;

FIG. 6 is an example flow diagram of a voice activated system according to the present disclosure;

FIG. 7 is another example flow diagram of a voice activated system according to the present disclosure, the voice activated system executing a speed control of an advanced driver assistance system; and

FIG. 8 is an example flow diagram of a method for a voice activated system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

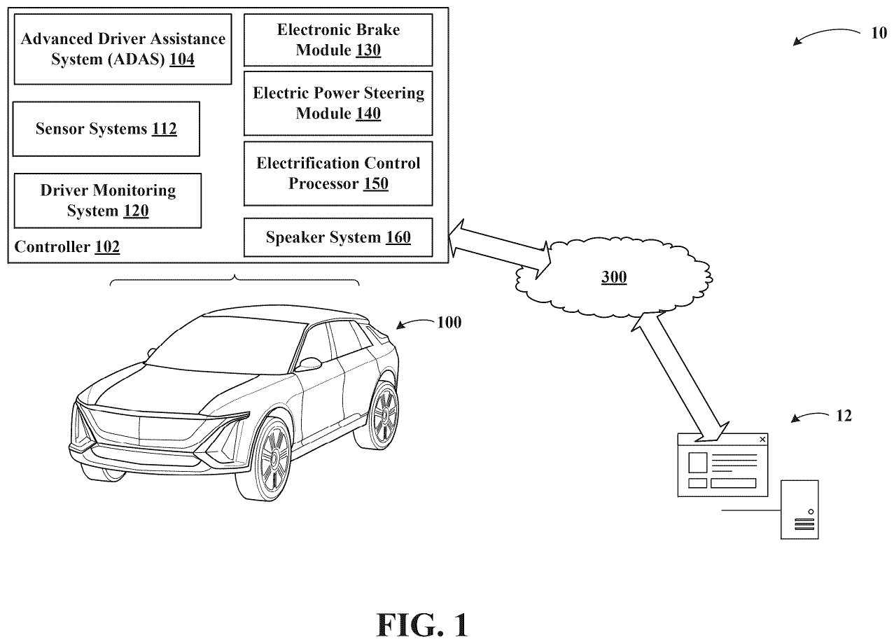

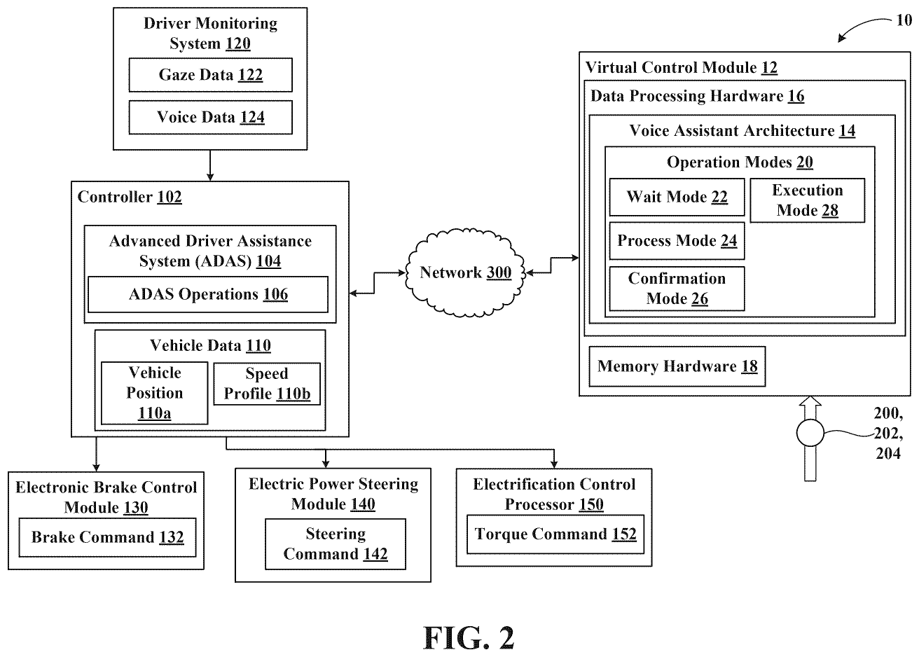

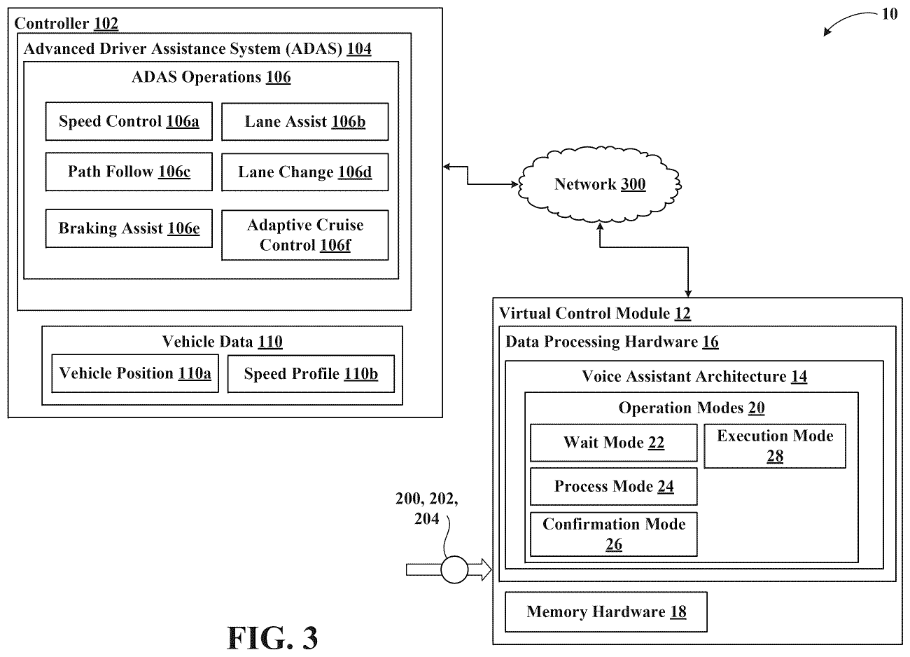

Referring to FIGS. 1-3, a voice activated system 10 is configured for operation with a vehicle 100 and includes a virtual control module 12 in communication with a controller 102 of the vehicle 100. For example, the virtual control module 12 is configured to receive a voice command 200 from a user and communicates the voice command 200 with the controller 102 via a network 300. The network 300 may be configured as a variety of communication networks and/or systems that allow communication between the virtual control module 12 and the controller 102 of the vehicle 100. For example, the network 300 may include, but is not limited to, WiFi®, cellular networks, built-in networks of the vehicle 100, ultra-wideband, Bluetooth®, and/or any other practicable communication system to assist communication between the virtual control module 12 and the controller 102 of the vehicle 100. The virtual control module 12 may be configured separately from the vehicle 100 and/or may be integrated with the vehicle 100. For example, the virtual control module 12 may be configured as part of a user device that is in communication with the vehicle 100 via the network 300.

The vehicle 100 is equipped with an advanced driver assistance system (ADAS) 106 configured to execute ADAS operations 106. The ADAS operations 106 include, but are not limited to, speed control 106a, lane assist 106b, path follow 106c, lane change 106d, braking assist 106e, and adaptive cruise control 106f. In some instances, the ADAS operations 106 may include predefined ADAS operations 106. For example, the speed control 106a may include a predefined step slowdown function. The controller 102 is configured to execute the ADAS 104 in response to a voice command 200 received by the virtual control module 12. The controller 102 also utilizes vehicle data 110 in combination with the ADAS 104 to execute the ADAS operations 106. The vehicle data 110 may include, but is not limited to, a vehicle position 110a and a speed profile 110b of the vehicle 100.

For example, the vehicle position 110a may be utilized by the ADAS 104 when executing the ADAS operations 106, such as lane assist 106b and/or lane change 106d, among others. The speed profile 110b may be utilized to execute the speed control 106a and/or adaptive cruise control 106f of the ADAS operations 106, among others. The vehicle data 110 is captured during operation of the vehicle 100 via various sensor systems 112 of the vehicle 100. The vehicle 100 may also be equipped with a driver monitoring system 120 configured to capture gaze data 122. The gaze data 122 may be received by the controller 102 and communicated with the virtual control module 12 during execution of a voice assistant architecture 14 of the virtual control module 12, described below. For example, a user may issue a voice command 200 and the driver monitoring system 120 may capture a gaze of the user as gaze data 122. The gaze data 122 may be shared with the virtual control module 12 from the controller 102, described in more detail below. The driver monitoring system 120 may also be utilized to capture voice data 124 from the driver for use with the voice assistant architecture 14, described below.

The vehicle 100 may also be equipped with an electronic brake control module 130 configured to execute a brake command 132, an electric power steering module 140 configured to execute a steering command 142, and an electrification control processor 150 configured to execute a torque command 152. The controller 102 is communicatively coupled with each of the electronic brake control module 130, the electric power steering module 140, and the electrification control processor 150 to implement one or more of the ADAS operations 106. Each ADAS operation 106 may be associated with one or more of the electronic brake control module 130, the electric power steering module 140, and the electrification control processor 150. For example, the brake command 132 of the electronic brake control module 130 may be a result of the ADAS operation 106 of braking assist 106e.

With further reference to FIGS. 1-3, the virtual control module 12 includes the voice assistant architecture 14 configured to be executed by data processing hardware 16 of the virtual control module 12. The virtual control module 12 may also include memory hardware 18 in communication with the data processing hardware 16. The memory hardware 18 stores instructions that, when executed by the data processing hardware 16, cause the data processing hardware 16 to execute operations, such as the voice assistant architecture 14. The data processing hardware 16 may be configured as a natural language processor, such that the voice command 200 received by the virtual control module 12 may be provided in a normal speech pattern. For example, the data processing hardware 16 may be configured as a machine learning processor configured to interpret, manipulate, and comprehend human language.

The voice assistant architecture 14 is configured to receive the voice command 200 and select from one or more operation modes 20 based on the voice command 200. For example, the voice assistant architecture 14 processes the voice command 200 to determine which operation mode 20 to execute. The operation modes 20 include a wait mode 22, a process mode 24, a confirmation mode 26, and an execution mode 28. The voice assistant architecture 14 remains in the wait mode 22 until a voice command 200 is received by the virtual control module 12. Once the voice assistant architecture 14 receives and processes the voice command 200, the virtual control module 12 communicates the voice command 200 with the controller 102 for validation.

The controller 102 is configured to validate whether the voice command 200 is directed to a valid ADAS operation 106 and that the voice command 200 includes unambiguous instruction. If the controller 102 determines that the voice command 200 is invalid or is ambiguous, then the controller 102 communicates with the virtual control module 12 to reject the voice command 200. In response, the virtual control module 12 may alert the user of the failure to satisfy the conditions of the voice command 200, and the voice assistant architecture 14 may return to the wait mode 22. If the voice command 200 is valid and unambiguous, the controller 102 communicates the validation to the virtual control module 12 for execution of the voice command 200.

Once the voice assistant architecture 14 and the controller 102 execute and/or complete the ADAS operation 106, the voice assistant architecture 14 returns to the wait mode 22 until a future voice command 200 is received. In some configurations, the voice assistant architecture 14 may be configured to enter the process mode 24 in response to a wake-up command 202. For example, the wake-up command 202 may include, but is not limited to, the user saying “hey assistant” or some other similar wake-up command 202 that may be recognized by the voice assistant architecture 14 to enter the process mode 24.

The process mode 24 of the voice assistant architecture 14 is configured to process the voice command 200. In some instances, the voice assistant architecture 14 may be configured to execute the process mode 24 and subsequently proceed with executing the execute mode 28. In such a configuration, the voice assistant architecture 14 enters the execute mode 28 and communicates with the controller 102 to execute the ADAS operation 106 indicated based on the processed voice command 200. In other configurations, the voice assistant architecture 14 is configured to enter the confirmation mode 26 following the process mode 24. The confirmation mode 26 is configured as a mode in which the voice assistant architecture 14 verifies with the user what was processed from the voice command 200. In some configurations, the voice assistant architecture 14 may be configured to enter the process mode 24 in response to a wake-up command 202.

For example, if the voice command 200 included language such as “activate adaptive cruise control”, then the voice assistant architecture 14 may confirm the voice command 200 with the user by projecting the voice command 200 via a speaker system 160 of the vehicle 100. In this example, the voice assistant architecture 14 may project “activate adaptive cruise control, is that correct?” In another example, the voice assistant architecture 14 may project the voice command 200 back to the user without prompting for confirmation. Regardless of the configuration, the user may cancel the voice command 200 by speaking various indications and/or taking corrective action of the vehicle 100. In one non-limiting example, the user may respond to the confirmation mode 26 of the voice assistant architecture 14 by stating “no,” “cancel,” and/or may use other natural language phrases to indicate cancellation of the voice command 200.

If the voice assistant architecture 14 is configured to receive a confirmation command 204 from the user, then the voice assistant architecture 14 enters the wait mode 22 until the confirmation command 204 is received. The confirmation command 204 may be captured by the driver monitoring system 120 and communicated with the virtual control module 12 via the controller 102. If the confirmation command 204 is received and/or if the voice assistant architecture 14 is not configured to receive the voice assistant architecture 14 enters the execution mode 28. The execution mode 28 is defined by the voice assistant architecture 14 communicating with the controller 102 to execute one or more of the ADAS operations 106. Once the execution mode 22 is completed, the voice assistant architecture 14 returns to the wait mode 22.

A user may customize the voice assistant architecture 14 to pass through or execute different operation modes 20. For example, the user may customize the voice assistant architecture 14 to repeat the voice command 200 back via projection through the speaker system 160 but may have the confirmation command 204 turned off. In this configuration, the voice assistant architecture 14 projects the voice command 200 back to the user and proceeds with entering the execution mode 28. In other configurations, the user may configure the voice assistant architecture 14 to wait for the confirmation command 204 before proceeding with the execution mode 28.

Referring still to FIGS. 1-3, the voice assistant architecture 14 may also receive the gaze data 122 from the controller 102, which may be utilized as part of the process mode 24. For example, the voice command 200 may include information indicating a directional lane change (i.e., left or right). The voice assistant architecture 14 may receive the gaze data 122 from the controller 102 to verify the direction based on a gaze of the driver. The gaze data 122 may reflect the driver looking at one of a left rear view mirror or a right rear view mirror and/or glancing over a left shoulder or right shoulder. The gaze data 122 may assist the voice assistant architecture 14 in processing the voice command 200 and enhancing the confirmation mode 26. The confirmation mode 26 may be enhanced by the gaze data 122, as the accuracy of the processed voice command 200 by the voice assistant architecture 14 may be improved by the gaze data 122.

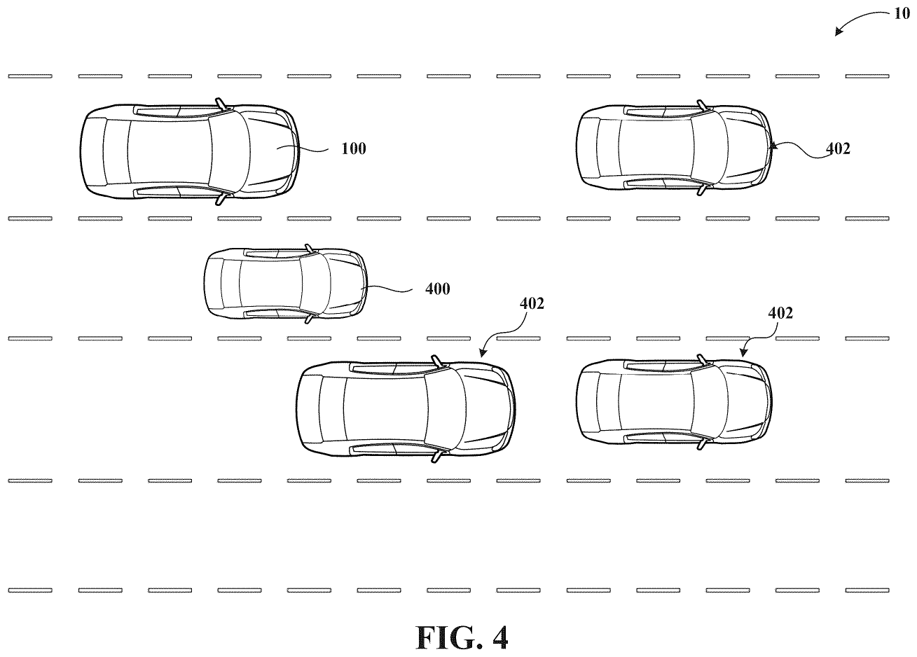

In one non-limiting example, illustrated in FIG. 4, the driver monitoring system 120 may capture the driver observing a secondary vehicle 400 attempting to merge into traffic 402. The driver may issue a voice command 200 requesting activation of the path follow 106c and speed control 106a ADAS operations 106, which would result in maintaining the vehicle position 110a and allow the secondary vehicle 400 to merge into the traffic 402. The voice assistant architecture 14 may process that voice command 200 and receive the gaze data 122 indicating the driver observing the secondary vehicle 400 to confirm the voice command 200 and, ultimately, execute the ADAS operations 106. The gaze data 122 may be utilized by the voice assistant architecture 14 to execute any one of the ADAS operations 106. For example, the gaze data 122 may indicate that the driver is looking to make a lane change and the driver may subsequently or simultaneously issue a voice command requesting execution of the ADAS operations 106 to lane change 106d. The voice assistant architecture 14 may utilize both the gaze data 122 and the voice command 200 to determine which of the ADAS operations 106 the driver is requesting to have activated.

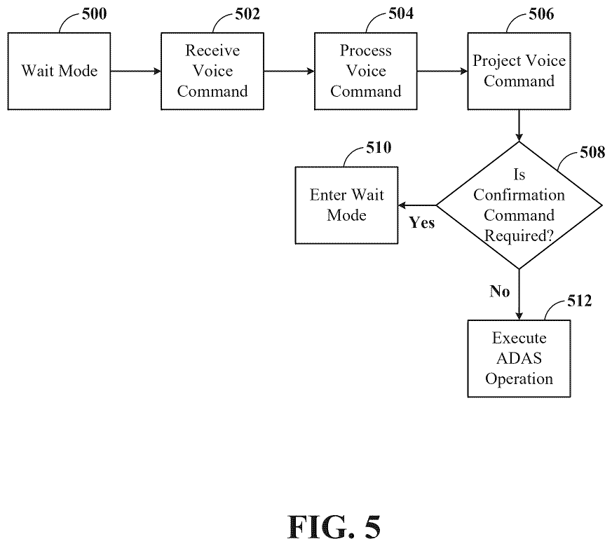

Referring to FIG. 5, an exemplary flow diagram of the voice activated system 10 is illustrated. At 500, the voice assistant architecture 14 is in wait mode 22 and receives, at 502, a voice command 200. The voice assistant architecture 14 enters, at 504, the process mode 24 and processes the voice command 200. At 506, the voice assistant architecture 14 confirms the voice command 200. Optionally, the voice assistant architecture 14 may project, at 506, the voice command 200 via the speaker system 160 of the vehicle 100. At 508, the virtual control module 12 determines whether the confirmation command 204 is required. If the voice assistant architecture 14 is configured to receive a confirm command 204, the voice assistant architecture 14 enters the wait mode 22, at 510, until the confirm command 204 is received. If the voice assistant architecture 14 is not configured to receive a confirm command 204, then the voice assistant architecture 14 enters, at 512, the execute mode 28, and the controller 102 executes the ADAS operation 106 based on the voice command 200.

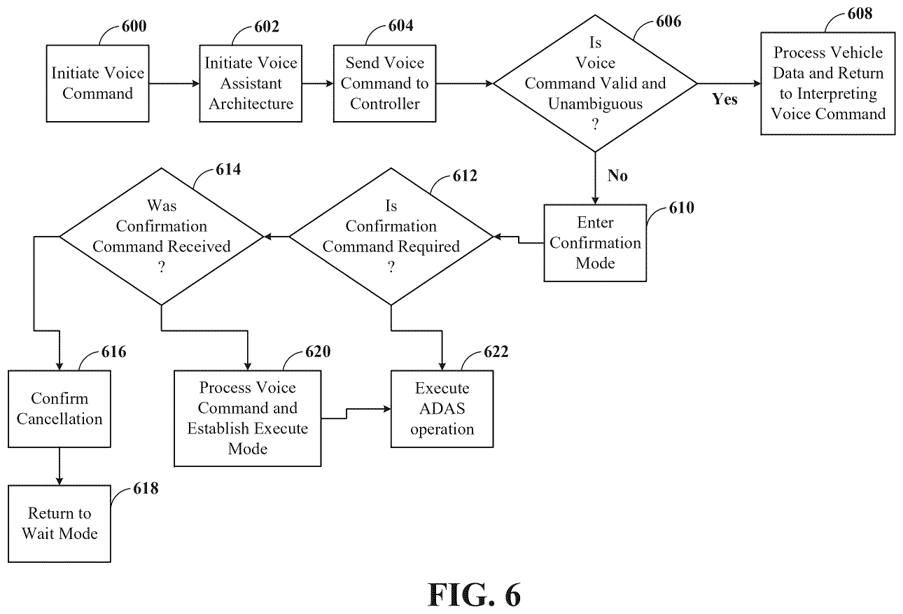

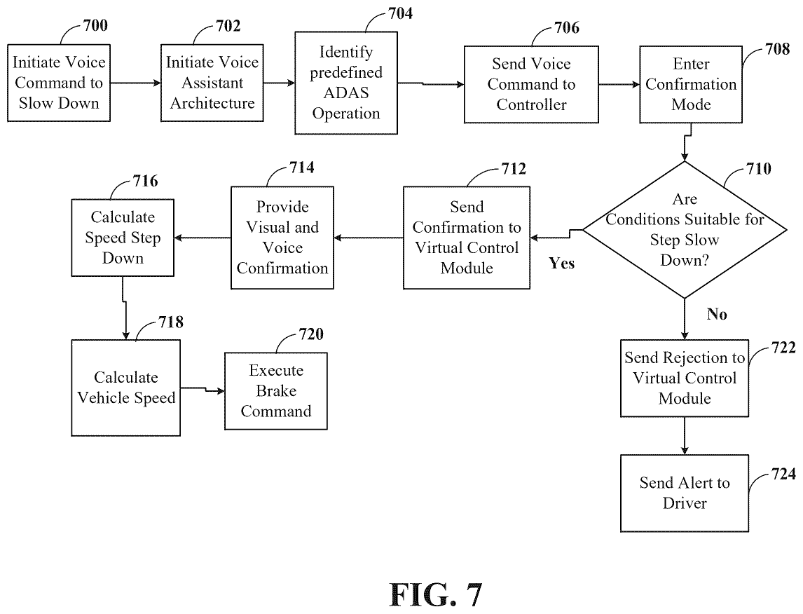

Referring to FIGS. 6 and 7, exemplary flow diagrams are illustrated for one example of operation of the voice activated system 10 to execute the speed control 106a of the ADAS operations 106. At 600, the driver initiates a voice command 200 and, at 602, the virtual control module 12 initiates the voice assistant architecture 14. The virtual control module 12, at 604, sends the voice command 200 to the controller 102 for validation, and the controller 102 determines, at 606, whether the voice command 200 is valid and unambiguous. If the controller 102 determines that the voice command 200 is not valid and/or is ambiguous, then the controller 102, at 608, processes the vehicle data 110 and returns to the virtual control module 12 interpreting the voice command 200.

If the voice command 200 is valid and unambiguous, then the voice assistant architecture 14 enters the confirmation mode 26, and the virtual control module 12 determines, at 610, whether a confirmation command 204 is required before proceeding to the execution mode 28. If not, then the virtual control module 12 may proceed with execution. If yes, the virtual control module 12 determines, at 612, whether the confirmation command 204 was received. If not, then the virtual control module 12 confirms, at 614, cancellation of the voice command 200 and returns, 618, to the wait mode 22. If the confirmation command 204 is received, the virtual control module 12 processes, at 620, the voice command 200 and establishes the execute mode 28. At 616, the voice activated system 10 executes the voice command 200 using both the virtual control module 12 and the controller 102.

With reference to FIG. 7, a voice command 200 is initiated, at 700, and the voice assistant architecture 14 is initiated, at 702. A predefined ADAS operation 106 is identified, at 704, and the virtual control module 12 sends, at 706, the voice command 200 to the controller 102. At 708, the voice assistant architecture 14 enters the confirmation mode 26, and the controller 102 determines, at 710, whether conditions are suitable for a step slowdown. If conditions are suitable, then the controller 102 sends, at 712, a confirmation to the virtual control module 12. The virtual control module 12 provides visual and voice confirmation to the user, at 714, and the controller 102 calculates, at 716, a speed step down. The controller 102 also calculates, at 718, the vehicle speed 110a and executes, at 720, a brake command 132. If the conditions are not suitable, then the controller 102 sends, at 722, a rejection to the virtual control module 12, and the virtual control module 12 sends an alert to the driver, at 724.

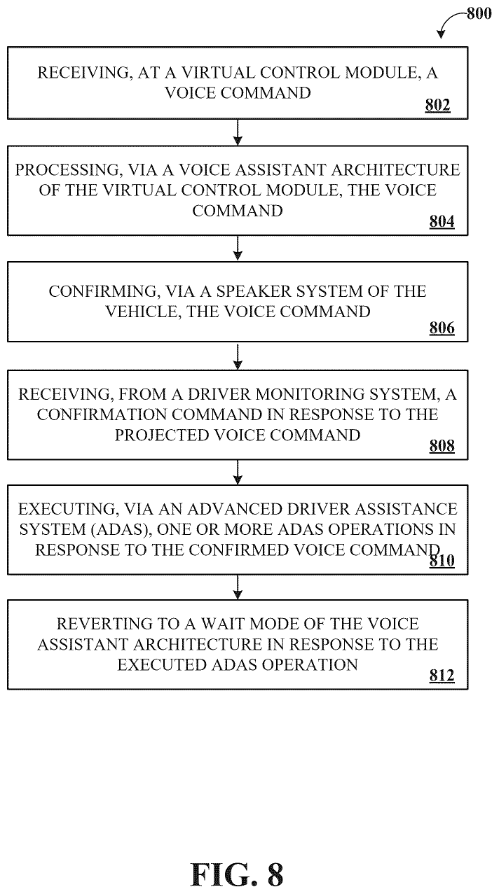

Referring to FIG. 8, an exemplary method 800 of the voice activated system 10 is illustrated. At 802, the virtual control module 12 receives a voice command 200. At 804, the voice assistant architecture 14 of the virtual control module 12 processes the voice command 200. The voice assistant architecture 14 confirms, at 806, via a speaker system 160 of the vehicle 100, the voice command 200. At 808, the virtual control module 12 receives a confirmation command 204 from a driver monitoring system 120 in response to the projected voice command 200. An advanced driver assistance system (ADAS) 104 executes, at 810, one or more ADAS operations 106 in response to the confirmed voice command 200. At 812, the voice assistant architecture 14 reverts to a wait mode 22 of the voice assistant architecture 14 in response to the executed ADAS operation 106.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at a virtual control module, a voice command;
processing, via a voice assistant architecture of the virtual control module, the voice command;
confirming, via the voice assistant architecture, the voice command; and
executing, via an advanced driver assistance system (ADAS) of a vehicle, one or more ADAS operations in response to the confirmed voice command.

2. The method of claim 1, wherein confirming the voice command includes projecting, via a speaker system of the vehicle, the voice command.

3. The method of claim 2, wherein confirming the voice command includes receiving, from a driver monitoring system, a confirmation command in response to the projected voice command.

4. The method of claim 1, wherein the voice assistant architecture is configured with operation modes, the operation modes including at least one of a wait mode, a process mode, a confirmation mode, and an execution mode.

5. The method of claim 4, further including reverting to the wait mode of the voice assistant architecture in response to the executed ADAS operation.

6. The method of claim 1, wherein executing the one or more ADAS operations includes executing at least one of a brake command, a steering command, and a torque command.

7. The method of claim 1, wherein the one or more ADAS operations includes one or more of speed control, lane assist, path follow, lane change, braking assist, and adaptive cruise control.

8. The method of claim 1, wherein confirming the voice command includes receiving gaze data, at the virtual control module, from a driver monitoring system of the vehicle.

9. The method of claim 1, wherein executing the one or more ADAS operations includes determining at least one of a vehicle position and a speed profile of the vehicle.

10. A voice activated system for a vehicle, the voice activated system comprising:
data processing hardware; and
memory hardware in communication with the data processing hardware, the memory hardware storing instructions that when executed on the data processing hardware cause the data processing hardware to perform operations comprising:
receiving, at a virtual control module, a voice command;
processing, via a voice assistant architecture of the virtual control module, the voice command;
confirming, via a speaker system of a vehicle, the voice command; and
executing, via an advanced driver assistance system (ADAS), one or more ADAS operations in response to the confirmed voice command.

11. The voice activated system of claim 10, wherein confirming the voice command includes projecting, via a speaker system of the vehicle, the voice command.

12. The voice activated system of claim 11, wherein confirming the voice command includes receiving, from a driver monitoring system, a confirmation command in response to the projected voice command.

13. The voice activated system of claim 10, wherein the voice assistant architecture is configured with operation modes, the operation modes including at least one of a wait mode, a process mode, a confirmation mode, and an execution mode.

14. The voice activated system of claim 13, further including reverting to the wait mode of the voice assistant architecture in response to the executed ADAS operation.

15. The voice activated system of claim 10, wherein executing the one or more ADAS operations includes executing at least one of a brake command, a steering command, and a torque command.

16. The voice activated system of claim 10, wherein the one or more ADAS operations includes one or more of speed control, lane assist, path follow, lane change, braking assist, and adaptive cruise control.

17. The voice activated system of claim 10, wherein confirming the voice command includes receiving gaze data, at the virtual control module, from a driver monitoring system of the vehicle.

18. The voice activated system of claim 10, wherein executing the one or more ADAS operations includes determining at least one of a vehicle position and a speed profile of the vehicle.

19. A voice activated system for a vehicle, the voice activated system comprising:
data processing hardware; and
memory hardware in communication with the data processing hardware, the memory hardware storing instructions that when executed on the data processing hardware cause the data processing hardware to perform operations comprising:
receiving, at a virtual control module, a voice command;
processing, via a voice assistant architecture of the virtual control module, the voice command;
confirming, via a speaker system of the vehicle, the voice command;
receiving, from a driver monitoring system, a confirmation command in response to the voice command;
executing, via an advanced driver assistance system (ADAS), one or more ADAS operations in response to the confirmed voice command; and
reverting to a wait mode of the voice assistant architecture in response to the executed ADAS operation.

20. The voice activated system of claim 19, wherein the voice assistant architecture is configured with operation modes, the operation modes including at least one of a wait mode, a process mode, a confirmation mode, and an execution mode.
